(19) United States
(12) Patent Application Publication
(10) Pub. No.: US 2014/0353977 A1
(43) Pub. Date: Dec. 4, 2014

(54) DE-HUMIDIFYING SYSTEM

(71) Applicant: SIEMENS AKTIENGESELLSCHAFT, MUNCHEN (DE)

(72) Inventor: CARSTEN MOELLER SOERENSEN, SDR. OMME (DK)

(73) Assignee: SIEMENS AKTIENGESELLSCHAFT, MUNCHEN (DE)

(21) Appl. No.: 14/205,479

(22) Filed: Mar. 12, 2014

(30) Foreign Application Priority Data
May 28, 2013 (EP) 13169451.5

(51) Int. Cl. F03D 9/00; F03D 11/00

(52) U.S. Cl. CPC F03D 9/002; F03D 11/005; F03D 11/0091
USPC 290/55

(57) ABSTRACT

The invention relates to a de-humidifying system of a wind turbine. In a wind turbine tower de-humidifying system the tower comprises a chamber in its interior. The chamber comprises an electrical arrangement that admits waste heat. A first tube connects the interior of the chamber to the exterior of the tower, to allow air from the exterior of the tower to flow into the chamber. A second tube connects the interior of the chamber to the exterior of the tower, to allow air from inside the chamber to flow to the exterior of the tower. A valve is arranged in the second tube to open a passage between the second tube and the interior of the tower, to allow air from the chamber to flow into the tower.

### CROSS-REFERENCE TO RELATED APPLICATIONS

This application claims priority to EP Application No. 13169451.5, having a filing date of May 28, 2013, the entire contents of which are hereby incorporated by reference.

### FIELD OF TECHNOLOGY

The invention relates to a de-humidifying system of a wind turbine.

### BACKGROUND

A wind turbine comprises a wind turbine rotor with rotor blades. The rotor is attached to the nacelle of the wind turbine. The nacelle is arranged on top of a tower. Wind turbines are used on-shore or off-shore. On-shore wind turbines are often located close to a coast. In the off-shore area and close to a cost the humidity in the ambient air can be quite high. Due to humidity in the ambient air and changing temperatures, humidity tends to condensate on cold surfaces in the wind turbine. Especially in the tower of the wind turbine the humility level can reach a level, where corrosion or mould can build inside the tower. Such high humidity levels are unwanted, as the humidity is a problem for the electrical systems in the tower and for the tower itself. It is therefore known to hinder water and moisture to get into the tower. In addition it is known to construct the tower in a way that reduces humidity in the tower by ventilation, for example natural ventilation or forced ventilation.

WO 1999/30031 A1 describes a wind power plant in which the generator is cooled by a cooling air flow generated by chimney effect in the tower of the wind power plant. A cabinet with power electronic is arranged in the lower part of the tower. The heat of the cabinet warms the air in the lower part of the tower. The warm air rises in the tower and fresh air is entering the tower in the lower area. This shows the disadvantage that air from outside the tower is flowing through the tower as long as the wind power plant is in operation.

It is also known to install an arrangement in the tower to dehumidify the air in the tower. The de-humidifying arrangements work on the principle of condensation or absorption. This shows the disadvantage that energy is needed to operate the de-humidifying systems.

### SUMMARY

An aspect of the invention is therefore to provide an improved de-humidifying system for a wind turbine tower.

In a wind turbine tower de-humidifying system the tower comprises a chamber in its interior. The chamber comprises an electrical arrangement that admits waste heat. A first tube connects the interior of the chamber to the exterior of the tower, to allow air from the exterior of the tower to flow into the chamber. A second tube connects the interior of the chamber to the exterior of the tower, to allow air from inside the chamber to flow to the exterior of the tower. A valve is arranged in the second tube to open a passage between the second tube and the interior of the tower, to allow air from the chamber to flow into the tower. The ambient air close to a wind turbine can show a high relative humidity due to a high level of humidity in the air combined with falling temperatures or due to rain. Due to wind and changing air pressure humid air and rain comes into the tower. With falling temperatures, the humidity condensates and the moisture level increases inside the tower of the wind turbine.

High humidity levels in the tower are a problem for electrical systems and for the tower itself, and are therefore unwanted. The relative humidity in the tower can be reduced by blowing warm air into the tower. The tower comprises electrical arrangements, such as a transformer or a converter arrangement. Electrical arrangements emit waste heat. Waste heat is unwanted heat due to losses in the electrical arrangement.

The electrical arrangement is arrangement within a chamber in the tower. The chamber separates the electrical arrangement from the rest of the tower. The chamber is ventilated and cooled by an air flow from the outside of the tower. A first tube connects the interior of the chamber to the exterior of the tower, to allow air from the exterior of the tower to flow into the chamber. A second tube connects the interior of the chamber to the exterior of the tower, to allow air from inside the chamber to flow to the exterior of the tower. Thus air from the exterior of the tower flows through the first tube into the chamber and through the second tube to the outside of the tower. Thus the chamber is ventilated and excess heat is removed from the chamber.

A valve is arranged in the second tube to open a passage between the second tube and the interior of the tower, to allow air from the chamber to flow into the tower. Thus, excess heat from the electrical arrangement in the chamber is guided into the tower. Thus, the interior of the tower is ventilated and heated. Thus, the relative air humidity in the tower is reduced and the tower is ventilated. Thus, the level of air moisture in the tower is lowered.

In addition, a filter can be arranged in the flow-path of the heated air, especially in the passage where the warm air is entering the interior of the tower. Thus, particles, like dust, sand or salt, are removed from the air and don't enter the interior of the tower.

The valve can be a mechanical valve that is pressure actuated or temperature actuated. Thus, the valve acts on a mechanical basis and does not need an electrical control. The first tube and the second tube are each connected to a through-hole in the tower wall. Thus, the air from outside tower can flow through the through-hole in the tower wall into the first tube and then into the chamber.

From the chamber, the air can flow through the second tube through the through-hole in the tower wall to the exterior of the tower. A through-hole in the tower wall can easily be planned and arranged by cutting a hole in the tower wall or by preparing the part of the tower wall during fabrication. Thus, the through-hole provides an easier access for the air into the tubes and the chamber. The tower comprises a door, and a first tube and/or the second tube are connected to a through-hole in a door. Thus, the through-holes are arranged in the door and no additional through-holes through the tower wall are needed. Thus, the tower wall is not weakened by the through-holes.

A first pressure sensor is arranged outside the tower and the second pressure sensor is arranged inside the tower. The entry of moisture or rain into the tower can be avoided by keeping the tower interior at a higher pressure than the air pressure on the outside of the tower. A ventilator is arranged in the first tube or in the second tube and can press air into the interior of the tower through the valve. The pressure level inside of the tower can be controlled by the second pressure sensor and be compared to the pressure outside of the tower, measured by the first pressure sensor. The valve is controlled in a way that the interior of the tower is kept at a higher pressure than the air pressure around the tower. The first pressure sensor and the second pressure sensor are connected to a pressure control unit, and the pressure control unit comprises a connection to the valve. The pressure control unit controls the valve in dependency on the pressure measured by the sensors. The first pressure sensor, measuring the air pressure at the outside of the tower, is connected to the control unit. The second pressure sensor, measuring the air pressure within the tower, is also connected to the control unit. The control unit is connected to the valve to control the valve. Thus, the air pressures outside of the tower and inside the tower are measured and a pressure difference can be calculated. The valve is controlled according to the pressure difference to keep the interior of the tower at a higher pressure than the air outside of the tower.

A normal wind turbine tower is not air-tight. Air can move into the tower and out of the tower through minor gaps. Gaps are present for example between the tower and the nacelle of the wind turbine, from the tower into the nacelle of the wind turbine, or at the door of the tower. Air is moving from the interior of the tower though the gaps to the outside of the tower when the interior of the tower is kept at a higher air pressure then the air surrounding the tower. Thus air is moving from the inside of the tower to the outside of the tower, and the air outside of the tower is kept from moving into the tower interior. Thus, air with a high humidity is kept from flowing into the tower interior. Thus, humidity is kept from the inside of the tower. Thus, the moisture inside of the tower is kept on a low level.

A first moisture sensor is arranged outside the tower and a second moisture sensor is arranged inside the tower. Thus, the level of moisture and humidity outside of the tower can be measured and the level of moisture and humidity inside of the tower can be measured. The first moisture sensor and the second moisture sensor are connected to a control unit. The moisture control unit comprises a connection to the valve. The moisture control unit controls the valve in dependency on the moisture measured by the sensors. Thus, the level of moisture and humidity outside of the tower and the level of moisture and humidity inside of the tower are measured, and the measuring values are compared by the control unit. Thus, the valve is controlled in dependency on the difference of the moisture levels inside and outside of the tower. Thus, more hot air can be guided into the tower and the moisture level inside of the tower is higher than the moisture level on the outside of the tower. Thus the relative humidity inside of the tower can be reduced.

The chamber comprises a temperature sensor to measure the temperature of the air in the chamber and a temperature sensor is connected to the control unit. The control unit is connected to the valve to control the valve. Thus the valve can be controlled in dependency on the temperature in the chamber. The temperature in the chamber is low when the wind turbine is not in operation or during the start up of the wind turbine. Thus the valve can be controlled in a way to guide air into the interior of the tower, when the temperature in the chamber of the tower reaches a certain level. Thus the heating and ventilation of the interior of the wind turbine tower is optimized. The valve is a three-way valve that opens a passage to the interior of the tower while it blocks the passage of the second tube to the exterior of the tower. Thus the air flowing through the second tube can be guided mainly completely into the interior of the tower. In addition, the pressure inside of the tower can be kept on a higher pressure level more easily.

A fan is installed in the first tube to force air to flow through the chamber and into the second tube. Thus the ventilation of the chamber is optimized. In addition, the chamber and a second tube can be kept on a higher air pressure level. A fan is installed in the second tube between the chamber and the valve, to suck air through the first tube and the chamber. Thus the air flow is forced through the second tube. Thus the air is pressed into the second tube and is forced through the valve. Thus the interior of the tower can be more easily kept on a higher pressure level than the air pressure surrounding the tower.

The electrical arrangement is a transformer and a chamber is explosion-tight. A wind turbine comprises a transformer, and the transformer is often installed within the tower of the wind turbine. The transformer is installed in an explosion-tight transformer chamber. A transformer generates a certain amount of waste heat. Thus the explosion-tight chamber needs to be cooled or ventilated. Thus the waste heat of the transformer can be used to lower the moisture level within the tower of the wind turbine.

The electrical arrangement comprises a converter. A converter of a wind turbine produces a certain amount of waste heat. Thus the converter of a wind turbine needs to be ventilated or cooled. The converter of the wind turbine can be easily ventilated or cooled when it is arranged within the chamber. In addition, the hot air can be used to lower the moisture level within the tower of the wind turbine.

### BRIEF DESCRIPTION

Embodiments of invention are shown in more detail by the help of figures, the figures do not limit the scope of the invention, wherein:

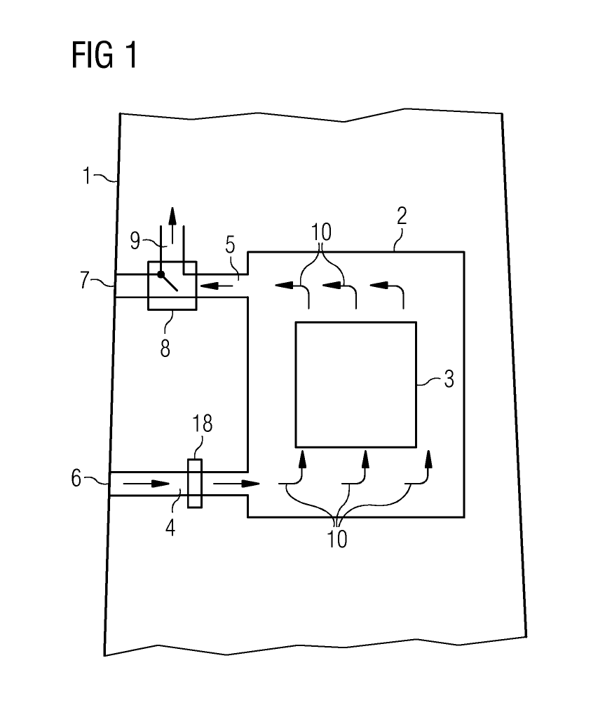

FIG. 1 shows a first embodiment of a de-humidifying system;

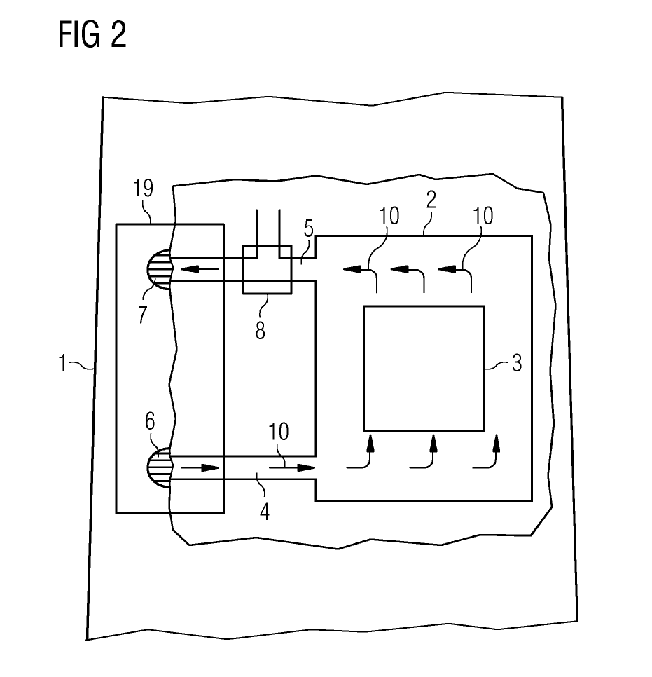

FIG. 2 shows a second embodiment of the de-humidifying system;

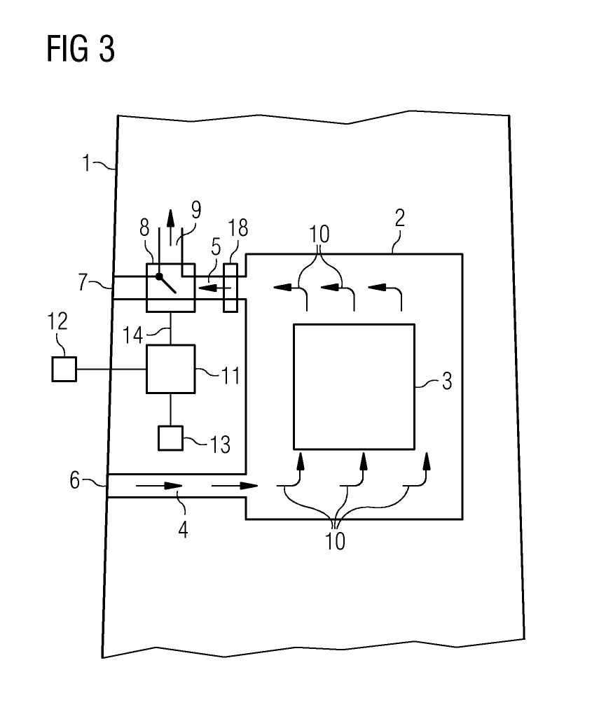

FIG. 3 shows an embodiment of a first control of the dehumidifying system; and

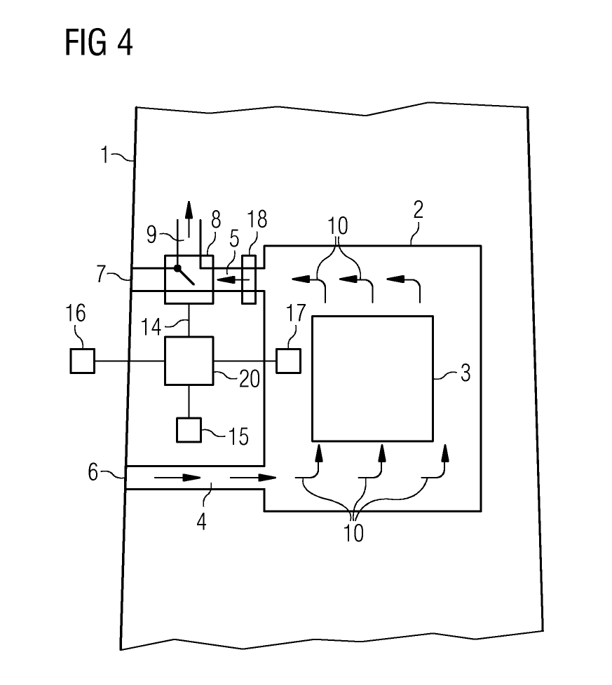

FIG. 4 shows an embodiment of a second control of the de-humidifying system.

### DETAILED DESCRIPTION

FIG. 1 shows a dehumidifying system of a wind turbine tower. The tower 1 comprises a chamber 2 with an electrical arrangement 3 that emits waste heat. The electrical arrangement 3 is cooled by an air flow 10.

A first tube 4 connects the interior of the chamber 2 to the exterior of the tower 1. The first tube 4 is connected to a through-hole 6 in the wall of the tower 1. The first tube 4 allows air to flow from the outside of the tower 1 into the chamber 2.

A second tube 5 connects the interior of the chamber 2 to the exterior of the tower 1. The second tube 5 is connected to a through-hole 7 in the tower wall. The second tube 5 allows air to flow from the chamber 2 to the exterior of the tower 1.

The air 10 flows through the through-hole 6 and the first tube 4 into the chamber 2. In the chamber 2 the air gets warmed by the electrical arrangement 3. The warm air flows along the second tube 5 and through the through-hole 7 to the exterior of the tower 1. A fan 18 is arranged at the tube 4 to force the air 10 to flow through the chamber 2 and the second tube 5.

A valve 8 is arranged at the second tube 5. The valve can direct the air flow 10 in the second tube 5 through a passage 9 into the interior of the tower 1.

FIG. 2 shows a second embodiment of a de-humidifying system of a wind turbine tower 1. The tower 1 comprises a chamber 2 with an electrical arrangement 3. The tower 1 comprises a door 19. The electrical arrangement 3 is cooled by an air flow 10. The air flow goes through the first tube 4, the chamber 2 and the second tube 5. The first tube 4 and/or the second tube 5 are connected to the outside of the tower 1 by through-holes 6, 7. The through-holes 6, 7 are arranged in the door of the wind turbine tower.

FIG. 3 shows an embodiment of a first control of the dehumidifying system. FIG. 3 also shows a detail of the de-humidifying system. A first pressure sensor 12 is arranged at the outside of the tower 1. The pressure sensor 12 measures the air pressure outside of the tower 1. The air flows through the through-hole 6 and the first tube 4 in to the chamber 2. There it cools the electrical arrangement 3. The air 10 flows then through the fan 18 and the second tube 5. The fan 18 sucks the air through the first tube 4 and the chamber 2 and forces the air through the second tube 5.

A second pressure sensor 13 is arranged in the interior of the tower. The pressure sensor 13 measures the air pressure in the tower 1. The two pressure sensors 12, 13 are connected to a control unit 11. The control unit 11 controls the valve 8 through a connection 14.

The valve 8 can direct the air flow 10 through the passage 9 into the interior of the tower 1. Thus the tower 1 can be kept at a higher air pressure then the air surrounding the tower 1, by forcing warm air into the interior of the tower 1.

The higher pressure in the tower hinders air from the outside of the tower 1 to enter the tower 1 through any other opening in the tower 1. In addition the warm, dry air from the chamber 2 warms the tower 1 and lowers the humidity in the tower 1.

FIG. 4 shows an embodiment of a second control of the de-humidifying system. In other words, FIG. 4 shows another embodiment of a control of the de-humidifying system of the wind turbine tower 1.

A first moisture sensor 16 is arranged outside of the tower 1. A second moisture sensor 15 is arranged in the interior of the tower. The first moisture sensor 16 and the second moisture sensor 15 are connected to a moisture control unit 20. The moisture control unit 20 comprises a connection 14 to the valve 8. The moisture control unit 20 controls the valve 8 in relation to the measurement of the moisture sensors 15, 16.

The air flows through the through-hole 6 and the first tube 4 into the chamber 2. There it cools the electrical arrangement 3. The air 10 flows then through the fan 18 and the second tube 5. The fan 18 sucks the air through the first tube 4 and the chamber 2 and forces the air through the second tube 5.

The valve 8 can direct the air flow 10 through the passage 9 into the interior of the tower 1 or through the through-hole 7 in the wall of the tower 1. In addition a temperature sensor 17 is arranged in the chamber 2 to measure the temperature of the air in the chamber 2. Thus the moisture control unit 20 controls the valve 8 in dependency of the moisture measured by the moisture sensors 15, 16 outside and inside the tower 1 and in dependency of the temperature of the air in the chamber 2.

When the air flow 10 is directed through the passage 9 into the tower 1, the air flow through the through-hole 7 to the outside of the tower 1 is reduced. The valve can also block the second tube 5 so that the air flow 10 is mainly directed through the passage 9.

The illustration in the drawings is in schematic form. It is noted that in different figures, similar or identical elements are provided with the same reference signs.

Although the present invention has been described in detail with reference to the preferred embodiment, it is to be understood that the present invention is not limited by the disclosed examples, and that numerous additional modifications and variations could be made thereto by a person skilled in the art without departing from the scope of the invention.

It should be noted that the use of “a” or “an” throughout this application does not exclude a plurality, and “comprising” does not exclude other steps or elements. Also elements described in association with different embodiments may be combined. It should also be noted that reference signs in the claims should not be construed as limiting the scope of the claims.

1. A wind turbine tower de-humidifying system:
wherein the tower includes a chamber having an interior,
wherein the chamber includes an electrical arrangement that emits waste heat,
wherein a first tube connects the interior of the chamber to an exterior of the tower to allow air from the exterior of the tower to flow into the chamber,
wherein a second tube which connects the interior of the chamber to the exterior of the tower to allow air from the interior of the chamber to flow to the exterior of the tower, and
wherein a valve is arranged in the second tube to open a passage between the second tube and the interior of the tower to allow air from the chamber to flow into the tower.

2. The wind turbine tower de-humidifying system according to claim 1, wherein the first tube and the second tube are each connected to a through-hole in a tower wall.

3. The wind turbine tower de-humidifying system according to claim 1, wherein the tower comprises a door, and the first tube and/or the second tube are connected to a through-hole in the door.

4. The wind turbine tower de-humidifying system according to claim 1, further comprising a first pressure sensor arranged outside the tower and a second pressure sensor arranged inside the tower.

5. The wind turbine tower de-humidifying system according to claim 4, wherein the first pressure sensor and the second pressure sensor are connected to a pressure control unit, and the pressure control unit comprises a connection to the valve, so that the pressure control unit controls the valve in dependency on the pressure measured by the first pressure sensor and the second pressure sensor.

6. The wind turbine tower de-humidifying system according to claim 1, further comprising a first moisture sensor arranged outside the tower and a second moisture sensor arranged inside the tower.

7. The wind turbine tower de-humidifying system according to claim 6, wherein the first moisture sensor and the second moisture sensor are connected to a moisture control unit, and the moisture control unit comprises a connection to the valve, so that the moisture control unit controls the valve in dependency on the moisture measured by the first moisture sensor and the second moisture sensor.

8. The wind turbine tower de-humidifying system according to claim 5, wherein the chamber comprises a temperature sensor to measure a temperature of the air in the chamber and the temperature sensor is connected to the control unit.

9. The wind turbine tower de-humidifying system according to claim 1, wherein the valve is a three-way valve that opens the passage to the interior of the tower while it blocks the passage of the second tube to the exterior of the tower.

10. The wind turbine tower de-humidifying system according to claim 1, further comprising a fan installed in the first tube to force air to flow through the chamber and into the second tube.

11. The wind turbine tower de-humidifying system according to claim 1, further comprising a fan installed in the second tube between the chamber and the valve to suck air through the first tube and the chamber.

12. The wind turbine tower de-humidifying system according to claim 1, wherein the electrical arrangement is a transformer, and the chamber is explosion tight.

13. The wind turbine tower de-humidifying system according to claim 1, wherein the electrical arrangement comprises a converter.
